(19) United States
(12) Patent Application Publication
(10) Pub. No.: US 2010/0026253 A1
(43) Pub. Date: Feb. 4, 2010

(54) Buck converter with surge protection

(76) Inventor: Shih-Yuan Wang, Tainan City (TW)

Correspondence Address: Juan Carlos A. Marquez;c/o Stites & Harbison PLLC, 1199 North Fairfax Street, Suite 900, Alexandria, VA, 22314-1437, US

(21) Appl. No.: 12/219,896

(22) Filed: Jul. 30, 2008

(51) Int. Cl. G05F 1/571

(52) U.S. Cl. 323/276; 323/285

(57) ABSTRACT

A buck converter with surge protection comprises a transistor, a voltage clamp circuit, a control circuit, a rectifier diode, an inductor, an output capacitor and a resistor. The transistor is coupled to a input voltage. The voltage clamp circuit has a Zener diode. The Zener diode is coupled to the transistor for limiting gate-to-source voltage of the transistor. The control circuit is used for maintaining a constant output voltage independently of variance of the input voltage. The rectifier diode is used for commutating current maintained by the electromotive force generating at both terminals of the inductor. The inductor is used for storing energy according to the current flowing from the input voltage via the transistor. The output capacitor is used for smoothing a voltage of the inductor. The resistor is applied the smoothed voltage. Hence, the present invention may protect the high-performance power supply from the automotive over-voltage events.

### BACKGROUND OF THE INVENTION

1. Field of the Invention

The present invention relates generally to a surge protection device (SPD), and more particularly to a buck converter with surge protection that protects the high-performance power supply from the automotive over-voltage events.

2. Description of Prior Art

Conventional switching regulators regulate voltage and block automotive load-dump pulses.

Referring to FIG. 1, a schematic diagram of a conventional switching regulator is shown. The switching regulator includes a n-channel MOSFET 12, a Zener diode 14, a load 16, a resistor 28 and a DC-DC converter 30.

The DC power supply Vin has its positive terminal connected to the drain terminal of the n-channel MOSFET 12 and has its negative terminal grounded. The Zener diode 14 limits the gate-to-source voltage of the n-channel MOSFET 12 below the VGS(max). The n-channel MOSFET 12 operates in saturation when the input voltage Vin is below the breakdown voltage of the Zener diode 14. During the input voltage transient, the n-channel MOSFET 12 blocks the voltages higher than the Zener breakdown voltages. The n-channel MOSFET 12 can be completely turned off as soon as the input voltage Vin increases above the set limit during the load 16 dump. The n-channel MOSFET 12 remains off as long as the input voltage Vin remains above the set voltage. The DC-DC converter 30 converts a high voltage to a lower voltage to charge a battery and supply electric power to various electronic apparatuses.

However, conventional switching regulator has some drawbacks. For example, the disadvantage is too many components around it.

### SUMMARY OF THE INVENTION

The present invention provides a buck converter with surge protection to resolve the foregoing problems faced by the conventional switching regulator. The present invention also has the advantage to avoid complex architecture.

An object of the present invention is to provide a buck converter with surge protection, wherein the simplified architecture just needs a single MOS and a Zener diode therein.

In accordance with an aspect of the present invention, a buck converter with surge protection, comprising: a transistor coupled to a input voltage; a voltage clamp circuit having a Zener diode, the Zener diode being coupled to the transistor for limiting gate-to-source voltage of the transistor; a control circuit for maintaining a constant output voltage independently of variance of the input voltage; a rectifier diode for commutating current maintained by the electromotive force generating at both terminals of the inductor; an inductor for storing energy according to the current flowing from the input voltage via the transistor; an output capacitor for smoothing a voltage of the inductor; and a resistor being applied the smoothed voltage.

In the preferred embodiment of the invention, the transistor is a NMOS, and the voltage clamp circuit has a Zener diode.

In the preferred embodiment of the invention, the input voltage has its positive terminal connected to a drain terminal of the NMOS and has its negative terminal grounded.

In the preferred embodiment of the invention, the Zener diode limits the gate-to-source voltage of the NMOS below VGS(max).

In the preferred embodiment of the invention, the NMOS operates in saturation when the input voltage Vin is below the breakdown voltage of the Zener diode.

In the preferred embodiment of the invention, the NMOS 38 blocks the voltages higher than the Zener breakdown voltages during the input voltage transient.

In the preferred embodiment of the invention, current flows from the input voltage via the NMOS, when the NMOS is turned on.

In the preferred embodiment of the invention, electromotive force is generated at both terminals of the inductor, when the NMOS is turned off. In the preferred embodiment of the invention, the control circuit 40 controls pulse width modulation (PWM).

The present invention may best be understood through the following description with reference to the accompanying drawings, in which:

### BRIEF DESCRIPTION OF THE DRAWINGS

FIG. 1 shows a schematic diagram of a conventional switching regulator.

FIG. 2 shows a schematic diagram of a buck converter with surge protection of the preferred embodiment according to the present invention.

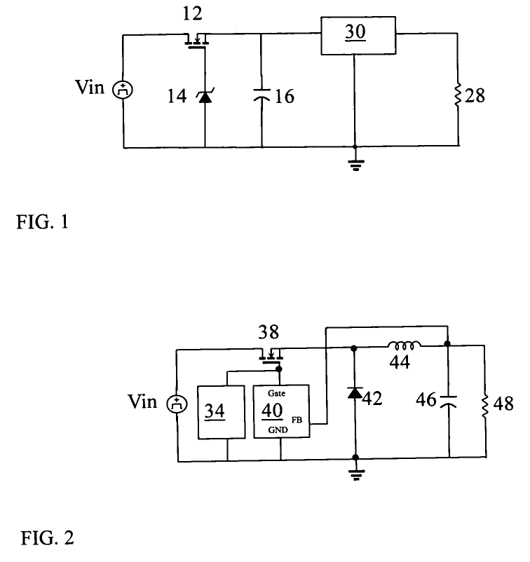

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

Referring to FIG. 2, a schematic diagram of a buck converter with surge protection of the first preferred embodiment according to the present invention is shown. The buck converter with surge protection includes a voltage clamp circuit 34, a NMOS 38, a control circuit 40, a rectifier diode 42, an inductor 44, an output capacitor 46 and a resistor 48.

The DC power supply Vin has its positive terminal connected to a drain terminal of the NMOS 38 and has its negative terminal grounded. The voltage clamp circuit 34 has a Zener diode. The Zener diode limits the gate-to-source voltage of the NMOS 38 below the VGS(max). The NMOS 38 operates in saturation when the input voltage Vin is below the breakdown voltage of the Zener diode. During the input voltage transient, the NMOS 38 blocks the voltages higher than the Zener breakdown voltages.

As shown in this figure, the voltage clamp circuit 34 has a Zener diode. Alternatively, the voltage clamp circuit 34 may have a linear regulator. The linear regulator is coupled to a gate terminal of the NMOS 38 and to a ground. The input voltage Vin is also connected to the linear regulator.

In another preferred embodiment of the invention, the voltage clamp circuit 34 may have an operational amplifier (OA) and an npn BJT. The OA has its inverting terminal connected to a reference voltage Vref and has its non-inverting terminal connected to the gate terminal of the NMOS 38. An output terminal of the OA is coupled to a base terminal of the npn BJT. A emitter terminal of the npn BJT is coupled to ground. A collector terminal of the npn BJT is coupled to the gate terminal of the NMOS 38.

When the NMOS 38 is turned on, current flows from the DC power supply Vin toward the inductor 44 via the NMOS 38, and a voltage of the inductor 44 at a side thereof connected to the resistor 48 is smoothed by the output capacitor 46 and applied to the resistor 48.

While the NMOS 38 is turned on, energy according to the current is stored in the inductor 44. And, when the NMOS 38 is turned off, electromotive force is generated at both terminals of the inductor 44, current maintained by the electromotive force commutates via the rectifier diode 42, and the energy stored is supplied to the resistor 48.

Since the control circuit 40 maintains a constant output voltage independently of variance of the input voltage Vin and the resistor 48, pulse width modulation (PWM) control is performed.

The present invention acts as a linear regulator to eliminate surge problems when the surge occurred. At the time the input voltage Vin remains constant, the present invention acts as a buck converter.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A buck converter with surge protection, comprising: a transistor coupled to a input voltage; a voltage clamp circuit coupled to said transistor for limiting gate-to-source voltage of said transistor; a control circuit for maintaining a constant output voltage independently of variance of said input voltage; a rectifier diode for commutating current maintained by said electromotive force generating at both terminals of said inductor; an inductor for storing energy according to said current flowing from said input voltage via said transistor; an output capacitor for smoothing a voltage of said inductor; and a load being applied said smoothed voltage.

2. The buck converter with surge protection according to claim 1, wherein said transistor is a NMOS and said load is a resistor.

3. The buck converter with surge protection according to claim 2, wherein said input voltage has its positive terminal connected to a drain terminal of said NMOS and has its negative terminal grounded.

4. The buck converter with surge protection according to claim 2, wherein said voltage clamp circuit limits said gate-to-source voltage of said NMOS below VGS(max).

5. The buck converter with surge protection according to claim 2, wherein said NMOS operates in saturation when said input voltage Vin is below said breakdown voltage of said voltage clamp circuit.

6. The buck converter with surge protection according to claim 2, wherein said NMOS 38 blocks said voltages higher than said breakdown voltages during said input voltage transient.

7. The buck converter with surge protection according to claim 2, wherein current flows from said input voltage via said NMOS, when said NMOS is turned on.

8. The buck converter with surge protection according to claim 2, wherein electromotive force is generated at both terminals of said inductor, when said NMOS is turned off.

9. The buck converter with surge protection according to claim 2, wherein said control circuit 40 controls pulse width modulation (PWM).

10. The buck converter with surge protection according to claim 2, wherein said voltage clamp circuit has a Zener diode.

11. The buck converter with surge protection according to claim 2, wherein said voltage clamp circuit has an operational amplifier (OA) and a BJT.

12. The buck converter with surge protection according to claim 2, wherein said voltage clamp circuit has a linear regulator.
